(19) United States
(12) Patent Application Publication
(10) Pub. No.: US 2006/0028464 A1
(43) Pub. Date: Feb. 9, 2006

(54) Method for reducing static charges on a panel and the structure thereof

(75) Inventor: Shu-Yun Huang, Taipei (TW)

Correspondence Address: MICHAEL W. TAYLOR, P.O. BOX 3791, ORLANDO, FL, 32802-3791, US

(73) Assignee: Arima Computer Corporation, Taipei (TW)

(21) Appl. No.: 10/913,873

(22) Filed: Aug. 6, 2004

(51) Int. Cl. G09G 5/00

(52) U.S. Cl. 345/211

(57) ABSTRACT

A method for reducing static charges on a panel is provided. The method includes the following steps: setting up a grounding circuit on a panel; covering transparent parts of said panel which are beyond the display region with a plurality of strip-shaped wirings, wherein said plurality of strip-shaped wirings are rectangular to avoid acute angles; conducting static charges from the covering piece to the grounding circuit by point discharging through a plurality of wires; and conducting the static charges out of the panel through the grounding circuit.

### FIELD OF THE INVENTION

The present invention relates to a method and a structure for reducing residual static charges on a panel, especially a liquid crystal display panel.

### BACKGROUND OF THE INVENTION

A thin film transistor liquid crystal display (TFT LCD) is one of the most popular 3C products. It gradually substitutes traditional cathode ray tube (CRT) displays and becomes a hit because it is thin, light, easy to carry, suitable for mass production, and has a working voltage and a low radiation.

Static charge is an important factor that affects the quality of many electronic products. If the amount of static charges accumulated on the circuit board, case, or other places is very high, the electronic products will be damaged. It is no exception for LCDs. If there are too many static charges accumulated on TFT LCD panels, the panels will be damaged and the pixels might not work properly. Therefore, many ways for avoiding the accumulation of static charges are provided in order to insure that LCD panels can be operated properly. Taiwanese Patent No. 00260801 has disclosed a method for preventing accumulation of static charges on display panels. It teaches that the antistatic coatings such as phosphor-tin oxides and fluorine-tin oxides are first smeared on the display panels, and then the display panels are heated to a high temperature to make the tin oxide layers permeate into the display panels. Therefore, the outside surfaces of the display panels are of high conductivity. Once the terminal of the panel is grounded, the panel is shielded from static and electromagnetic influences. The above is just one of the methods for solving static problems. For regular operation and good performance of panels, most big companies devote themselves to research into new methods for solving static problems more effectively.

Since there are plenty of causes of static charges, there come out different methods for reducing accumulation of static charges according to different causes. The following is one of the causes. When a TFT LCD panel is in its backend manufacturing process, a polarizer is stuck on the panel. After the protection membrane of the polarizer is ripped, static charges are generated. This phenomenon happens more frequently and is very serious especially in winter or dry areas; therefore, the amount of static charge accumulation is increased and the threat to products is getting higher.

The working principle of a LCD is to utilize liquid crystals as switches to control the amount of passed light generated by a backlight module so as to display different bright and dark areas on the screen. Moreover, in order to generate colorful pictures and to contain wide-viewing properties, a polarizer and a compensation plate are stuck to the panel in its backend process. In order to let the backlight pass through the circuit board, the electrodes must be transparent, and the most common material for these transparent electrodes is ITO. However, areas other than the display region of the panel must be covered with wirings during layout to avoid light leakage. Hence, unexpected light won't pass through and the quality of the display is enhanced.

FIG. 1 shows, in the prior art, the layout of the blank areas for avoiding light leakage. The display area of a panel is represented by the reference numeral 10; the triangular blank area is represented by the reference numeral 11; the enlargement of the triangular blank area 111 is represented by the reference numeral 12; the first rectangular blank area is represented by the reference numeral 13, and the second rectangular blank area is represented by the reference numeral. The wirings on the triangular blank area 11 are oblique; this can be obviously seen in the enlargement 12. Because the wirings are oblique, there are acute angles on the wirings. According to electromagnetism, static charges on a conductor accumulate on the points of the conductor, i.e., the sharper the points are, the more static charges accumulate thereon. Because of the high density of static charges, the electric fields around the points are so strong that devices are probably damaged by the influences of the electric fields. Hence, to protect devices from being damaged by static charges, elimination of static charges is required. On the other hand, if the amount of static charges is very high, it will take a long time to eliminate these static charges. A measurement shows that it took 40˜50 seconds to eliminate static charges on the wirings which are oblique as shown in FIG. 1.

In view of the previous discussion, it is an object of the present invention to provide a method for reducing static charges on a panel and the structure thereof.

### SUMMARY OF THE INVENTION

The main purpose of the present invention is to provide a method for reducing static charges on a panel and the structure thereof. Static charges on the panel can be reduced via this method and this structure. The circuits on the panel are hence protected, and the whole panel can work properly.

It is one object of the present invention to find out a more efficient way to eliminate residual static charges on a display panel. If the static charges are removed rapidly and effectively out of the panel, the panel can be operated more smoothly and less damage will occur.

According to one aspect of the present invention, a method for reducing static charges on a panel is provided. The method includes steps of setting up a grounding circuit on a panel; covering a transparent part of the panel with a covering piece, wherein the transparent part is other than a display region of the panel, and the covering piece is without an acute angle; conducting static charges from the covering piece to the grounding circuit by point discharging through a plurality of wires; and conducting the static charges out of the panel through the grounding circuit.

Preferably, the panel is a liquid crystal display panel.

Preferably, the covering piece includes a plurality of strip-shaped wirings.

Preferably, the plurality of strip-shaped wirings are rectangular to avoid an accumulation of the static charges.

Preferably, shape of the transparent parts is one of a triangle and a rectangle.

Preferably, the plurality of wires are made of a metal.

According to another aspect of the present invention, a structure for reducing static charges on a panel is provided. The structure includes a grounding circuit; a covering piece on a transparent part of a panel, wherein the transparent part is other than a display region of the panel; and a plurality of wires for conducting static charges from the covering piece to the grounding circuit by point discharging, and hence the static charges are conducted out of the panel.

Preferably, the panel is a liquid crystal display panel.

Preferably, the covering piece comprises a plurality of strip-shaped wirings.

Preferably, the plurality of strip-shaped wirings are rectangular to avoid an accumulation of the static charges.

Preferably, the shape of the transparent parts is one of a triangle and a rectangle.

Preferably, the plurality of wires are made of a metal.

According to still another aspect of the present invention, a structure for reducing static charges on a panel is provided. The structure includes a covering piece on a transparent part of a panel, wherein the transparent part is other than a display region of the panel.

Preferably, the panel is a liquid crystal display panel.

Preferably, the covering piece is a plurality of strip-shaped wirings.

Preferably, the plurality of strip-shaped wirings are rectangular to avoid an accumulation of the static charges.

Preferably, the shape of the transparent parts is one of a triangle and a rectangle.

The foregoing and other features and advantages of the present invention will be more clearly understood through the following descriptions with reference to the drawings, wherein:

### BRIEF DESCRIPTION OF THE DRAWINGS

FIG. 1 shows the layout of the blank region of the panel of the prior art; and

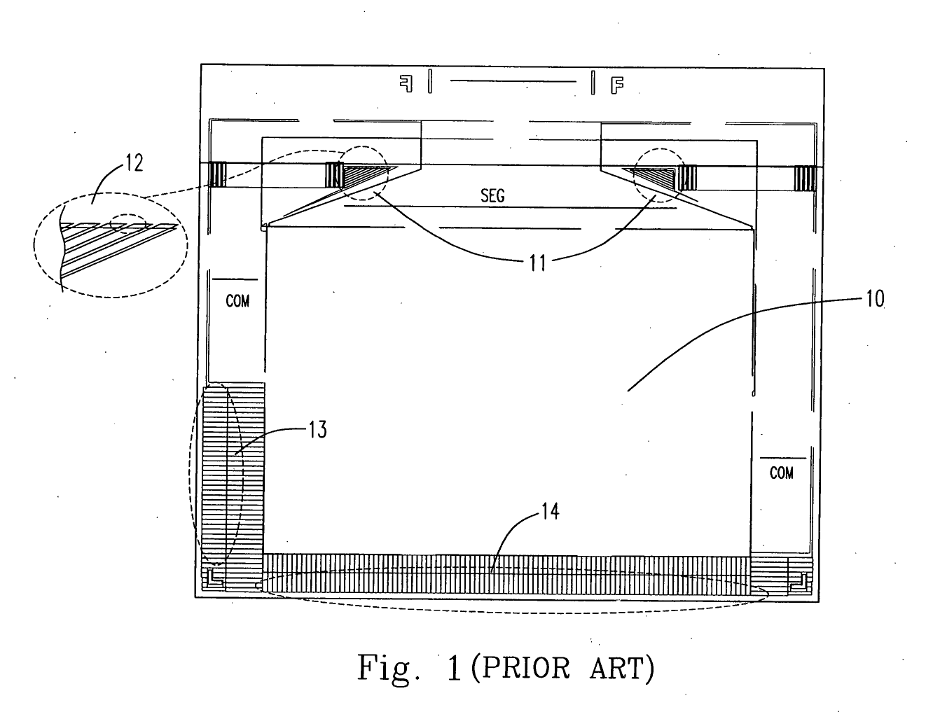

FIG. 2 shows the layout of the blank region of the panel according to one embodiment of the present invention.

### DETAILED DESCRIPTION OF THE PREFERRED EMBODIMENT

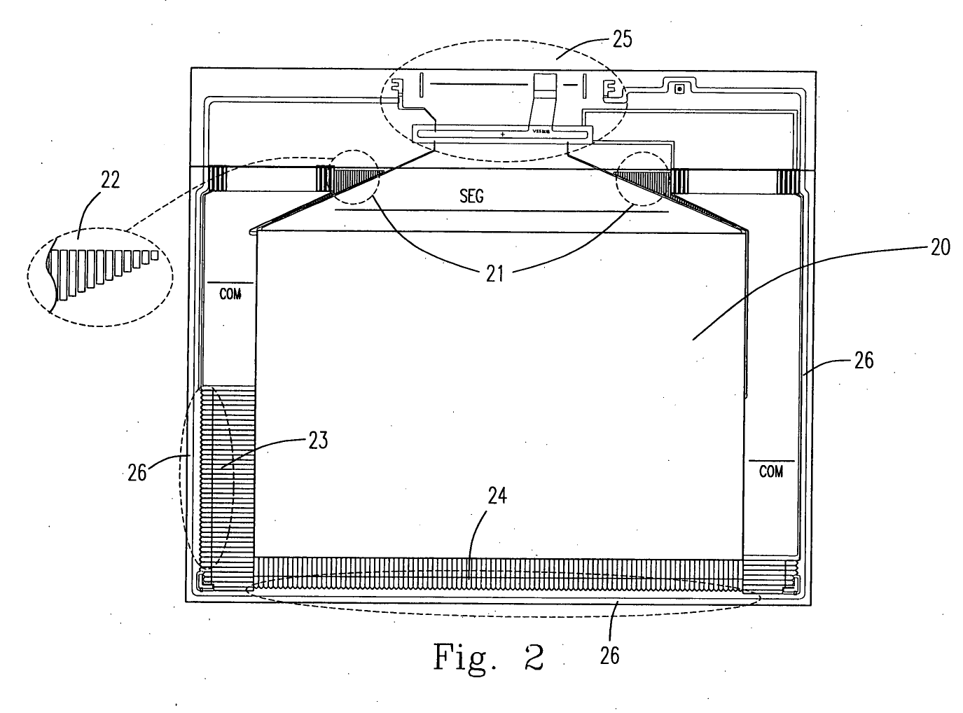

FIG. 2 shows a LCD panel. The display area of the panel is represented by the reference numeral 20; the triangular blank area is represented by the reference numeral 21; the enlargement of triangular blank area 21 is represented by the reference numeral 22; the first rectangular blank area is represented by the reference numeral 23; the second rectangular blank area is represented by the reference numeral 24; a grounding circuit is represented by the reference numeral 25, and the wires connecting the grounding circuit 25 and the wirings that cover the blank areas are represented by the reference numeral 26.

To prevent the unexpected backlight from passing through the triangular blank area 21, some wirings are used to cover it. The enlargement 22 shows that the layout of the wirings used in the present invention is different from that used in the prior art. The layout of the wirings used in the prior art is oblique, so it contains acute angles. However, the layout of the wirings used in the preset invention is strip-like, and more precisely, rectangular. Because each wiring is rectangular and hence there are no acute angles, the accumulation of static charges can be reduced. Moreover, the grounding circuit 25 is connected with the wirings on the triangular blank area 21 in order to eliminate residual static charges on the wirings. The function of the grounding circuit 25 is not only to eliminate the residual static charges rapidly, but also to remove the residual static charges almost completely. The grounding circuit 25 is connected not only with the wirings on the triangular blank area 21, but also with the first rectangular blank area 23 and the second rectangular blank area 24 via wires 26. Residual static charges on the first and the second rectangular blank areas 23 and 24 are removed from the panel via the wires 26 and the grounding circuit 25. A measurement shows that it takes only 2˜3 seconds to eliminate the residual static charges by the wirings and the grounding circuit provided in the present invention.

In the present invention, a special layout of the wirings on the blank areas and an added grounding circuit are provided to eliminate residual static charges on the panel, and therefore, the devices are prevented from being influenced by static charges. It is obvious that the present invention is better than the prior art, and hence it is a precious invention in this kind of industry.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A method for reducing static charges on a panel, comprising:
setting up a grounding circuit on a panel;
covering transparent parts of said panel which are beyond the display region with a plurality of strip-shaped wirings, wherein said plurality of strip-shaped wirings are rectangular to avoid acute angles;
conducting static charges from said covering piece to said grounding circuit by point discharging through a plurality of wires; and
conducting said static charges out of said panel through said grounding circuit.

2. The method as claimed in claim 1, wherein said panel is a liquid crystal display panel.

3. The method as claimed in claim 1, wherein said covering piece comprises a plurality of strip-shaped wirings.

4. The method as claimed in claim 3, wherein said plurality of strip-shaped wirings are rectangular to avoid an accumulation of said static charges.

5. The method as claimed in claim 1, wherein a shape of said transparent parts is one of a triangle and a rectangle.

6. The method as claimed in claim 1, wherein said plurality of wires are made of a metal.

7. A structure for reducing static charges on a panel, comprising:
a grounding circuit;
a covering piece on a transparent part of a panel, wherein said transparent part is other than a display region of said panel; and
a plurality of wires for conducting static charges from said covering piece to said grounding circuit by point discharging, and hence said static charges are conducted out of said panel.

8. The structure as claimed in claim 7, wherein said panel is a liquid crystal display panel.

9. The structure as claimed in claim 7, wherein said covering piece comprises a plurality of strip-shaped wirings.

10. The method as claimed in claim 9, wherein said plurality of strip-shaped wirings are rectangular to avoid an accumulation of said static charges.

11. The method as claimed in claim 7, wherein a shape of said transparent parts is one of a triangle and a rectangle.

12. The structure as claimed in claim 7, wherein said plurality of wires are made of a metal.

13. A structure for reducing static charges on a panel, comprising:
a covering piece on a transparent part of a panel, wherein said transparent part is other than a display region of said panel.

14. The structure as claimed in claim 13, wherein said panel is a liquid crystal display panel.

15. The structure as claimed in claim 13, wherein said covering piece is a plurality of strip-shaped wirings.

16. The method as claimed in claim 15, wherein said plurality of strip-shaped wirings are rectangular to avoid an accumulation of said static charges.

17. The method as claimed in claim 13, wherein a shape of said transparent parts is one of a triangle and a rectangle.
